(19) United States
(12) Patent Application Publication
(10) Pub. No.: US 2015/0149232 A1
(43) Pub. Date: May 28, 2015

(54) METHOD AND SYSTEM FOR SCHEDULING AN EVENT AT A COMPUTING DEVICE

(71) Applicant: OpenPeak Inc., Boca Raton, FL (US)

(72) Inventor: Carsten Michael Dietz, Boynton Beach, FL (US)

(21) Appl. No.: 14/529,638

(22) Filed: Oct. 31, 2014

Related U.S. Application Data
(60) Provisional application No. 61/898,646, filed on Nov. 1, 2013.

(51) Int. Cl. G06Q 10/10

(52) U.S. Cl. CPC G06Q 10/1095
USPC 705/7.19

(57) ABSTRACT

A method and system for scheduling an event at a computing device is described herein. The method includes the steps of receiving an event request at the computing device and—in response to the reception of the event request—presenting at least one event parameter. The method also includes the steps of receiving input related to the event parameter and automatically comparing the received input to schedule data. The method further includes the step of—based on the comparison of the received input to the schedule data—presenting one or more candidate time periods for the event that are in compliance with the received input.

### CROSS-REFERENCE TO RELATED APPLICATIONS

This patent application claims priority to U.S. Patent Application No. 61/898,646, filed on Nov. 1, 2013, which is incorporated herein by reference in its entirety.

### FIELD OF TECHNOLOGY

The present description relates to systems and methods for scheduling events at a computing device.

### BACKGROUND

Computing devices may be utilized for many useful functions, including time management of individuals or groups. For example, a user may employ a calendar application on a computing device to schedule business or personal meetings. Some users, such as busy employees of a company, may need to organize meetings frequently. As such, those users may end up spending a significant amount of valuable time scheduling meetings.

The process of scheduling a meeting on a computing device may be laborious and time-consuming for any number of reasons. For example, it may be difficult to coordinate a meeting requiring several participants, as the schedule of each participant may need to be taken into account to determine an acceptable meeting time. Such a challenge may be further compounded due to the logistics of the device. For instance, scrolling through multiple schedules on a relatively small screen of a mobile device may be a frustrating and error prone task. As time efficiency is beneficial in the workplace and in everyday life, there is a need for improved techniques for scheduling meetings at a computing device.

### SUMMARY

A method of scheduling an event at a computing device is disclosed herein. The method can include the steps of receiving, at the computing device, an event request and—in response to the receipt of the event request—presenting at least one event parameter. The method may also include the steps of receiving input related to the event parameter, automatically comparing the received input to schedule data, and—based on the comparison of the received input to the schedule data—presenting one or more candidate time periods for the event that are in compliance with the received input.

In one embodiment, the event parameter can be a last permissible time for the event, a duration of time for the event, a list of potential participants to be invited to the event, a time preference parameter, or a time restriction parameter. In another embodiment, the list of potential participants may be from a contact list.

In one arrangement, the candidate time periods for the event may be in full compliance with the received input. The method may also include the steps of presenting one or more alternate candidate time periods that are in partial compliance with the received input and presenting a non-compliance reason for the alternate candidate time periods. In addition, the method may include the steps of receiving a selection for at least one of the candidate time periods that is in compliance with the received input and automatically populating a calendar entry with information related to the selection of the candidate time period. The method may also include the step of presenting match ratings for the candidate time periods. In one arrangement, the match ratings may be based on the compliance of the candidate time periods with the received input.

In one embodiment, the schedule data may include a schedule of at least one of the potential participants, a schedule of operational hours of an organization, or information from a social networking tool. In another embodiment, the schedule data may include an event external to an organization.

Another method of scheduling an event at a computing device is also disclosed herein. The method may include the step of receiving, at the computing device, an event request. In one arrangement, the event request may include input related to at least one event parameter including a last permissible time for the event, a duration of time for the event, or a list of potential participants to be invited to the event. The method may also include the steps of automatically comparing the input with schedule data to generate one or more candidate time periods for the event in accordance with the input and presenting the candidate time periods for the event. In one arrangement, the candidate time periods may be presented in a calendar format such that days that are part of a calendar and that contain a candidate time period are distinguishable from days that are part of the calendar that do not contain candidate time periods. In addition, the method may include the step of presenting at least one event parameter from a set of event parameters to enable the receipt of the input related to the event parameter.

The method may also include the steps of determining, based on the input, that one or more additional event parameters are needed to schedule the event and prompting for the additional event parameters. In one arrangement, the generated candidate time periods may be in full compliance with the received input. The method may further include the step of presenting one or more alternate candidate time periods that are non-compliant with at least a portion of the received input. In one embodiment, the schedule data may include a schedule of at least one of the potential participants, a schedule of operational hours of an organization, or information from a social networking tool.

In one arrangement, the input may include a time preference parameter. The method may further include the steps of comparing the one or more candidate time periods with the time preference parameter to produce a set of match ratings and presenting the set of match ratings.

A computing device is also disclosed herein. The computing device may include an interface that is configured to receive input from a user and to present information to the user. The computing device may also include a processing unit that is communicatively coupled to the interface. The interface may also be configured to receive an event request and—in response to the receipt of the event request—present at least one event parameter. In one arrangement, the event parameter may be from a set of event parameters that includes a last permissible time for the event, a duration of time for the event, or a list of potential participants to be invited to the event. In another arrangement, the set of event parameters may further include a time preference parameter or a time restriction parameter.

The interface may also be configured to receive input related to the event parameter and to communicate the input to the processing unit. In addition, the interface may be configured to—based on an automatic comparison of the received input to a set of schedule data—present one or more candidate time periods for the event. In one arrangement, the processing unit may be configured to perform the automatic comparison and to generate the candidate time periods. In another arrangement, the interface may be a touch display, and the set of event parameters can include a time preference parameter or a time restriction parameter.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a computing device that is capable of scheduling events.

FIG. 2 illustrates an example of a method that can be used to schedule an event at a computing device.

FIG. 3 illustrates an example of a calendar application presenting an option to perform an event request.

FIG. 4 illustrates an example of a calendar application presenting event parameters.

FIG. 5 illustrates an example of a calendar application presenting candidate time periods for an event.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged between the components on a unidirectional or bidirectional (or multi-directional) manner, either wirelessly, through a wired connection or a combination of both. In addition, components may be communicatively coupled through direct or indirect connections, or a combination thereof. A “computing device” is defined as a component that is configured to perform some process or function for a user and includes both mobile and non-mobile devices. The terms “computer program medium” and “computer readable medium” are defined as one or more non-transitory components that are configured to store instructions that are to be executed by a processing unit.

An “application” or an “app” is defined as a program or programs that perform one or more particular tasks on a computing device. Examples of an application include programs that may present a user interface for interaction with a user or that may run in the background of an operating environment that may not present a user interface while in the background. The term “setting” is defined as a state or condition or some relation to a state or condition. The term “operating system” is defined as a collection of software components that directs a computing device's operations, including controlling and scheduling the execution of other programs and managing storage, input/output and communication resources. A “processing unit” is defined as one or more components that execute sets of instructions, and the components may be disparate parts or part of a whole unit and may not necessarily be located in the same physical location. The term “memory” or “memory element” is defined as one or more components that are configured to store data, either on a temporary or persistent basis. An “interface” is defined as a component or a group of components that enable(s) a device to communicate with one or more different devices, whether through hard-wired connections, wireless connections or a combination of both. The components of the interface may also enable the device to receive input from and to present information, whether through visual, audio, written, tactile or other methods, or any combination of such.

As explained earlier, a user may depend on a computing device for performing tasks such as time management, which may include scheduling appointments or events. In some cases, the scheduling process may be quite time-consuming, particularly when a meeting requires many participants. In addition, scheduling this or any type of meeting can be tedious when performed on a device that presents logistical challenges, such as a small screen or a keyboard that is difficult to use.

A method and system for scheduling an event at a computing device is described herein to address this problem. In particular, an event request may be received at the computing device and—in response to the reception of the event request—at least one event parameter may be presented. In addition, input related to the event parameter may be received, and the received input may be automatically compared to schedule data. Based on the comparison of the received input to the schedule data, one or more candidate time periods for the event may be presented. The candidate time periods may be in compliance with the received input.

As such, the method and system provide an easy way for events to be scheduled at the computing device. Such a feature may increase the efficiency of an organization or of individuals, as event scheduling may be performed in a timely manner. In addition, the feature may address logistical challenges associated with the device, thus leading to an improved user experience.

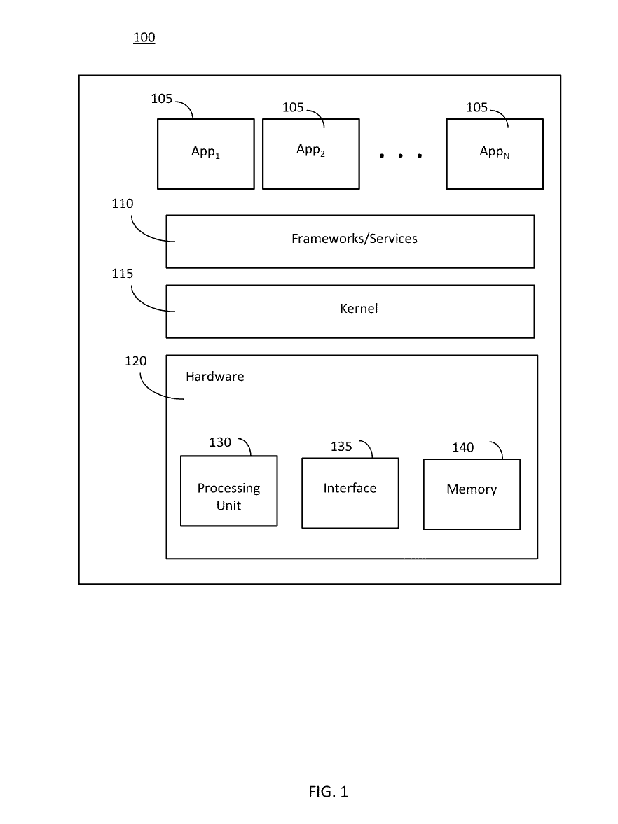

Referring to FIG. 1, an example of a computing device 100 that enables event scheduling is shown. The device 100 can include one or more applications 105, which may be completely or partially installed on the device 100 or elsewhere, such as on a server (not shown) to which the device 100 is communicatively coupled. As an example, the computing device 100 may be enabled to cause execution of an application 105 that actually executes at the server.

As is known in the art, the computing device 100 may include a frameworks/services level 110 that provides several abstraction layers that include system interfaces and that facilitate operation of the applications 105 and other functions of the device 100. As is also known in the art, the computing device 100 can include a kernel 115, which provides interfaces for the frameworks/services level 110 to interact with a hardware layer 120. The computing device 100 may further include an operating system and any suitable type of abstraction layers to enable applications that may be installed on the device 100 to interact with the components described here and other elements of the device 100.

As shown in the hardware layer 120, the computing device 100 may also include a processing unit 130, an interface 135 and a memory unit 140, either of which may be communicatively coupled to the processing unit 130. The memory unit 140 may be a single memory unit or may be comprised of multiple memory units that may operate independently or jointly and can include persistent memory, non-persistent memory or both. The interface 135 may be configured to support either wired or wireless communications with a variety of components, such as other computing devices, external networks, landline phones, desktop computers or the like, and may be configured to operate in accordance with various protocols. The computing device 100 may include multiple processing units 130 and interfaces 135 to carry out any of the functions described herein. Although not shown here, the computing device 100 may also include one or more components that are configured to accept input from a user or other device, such as a mouse, a touch screen, a microphone, or any other suitable component. In addition, the computing device 100 may be configured to present data, information or the like to a user or other component and may include, for example, a graphical display, speakers, or any other suitable component.

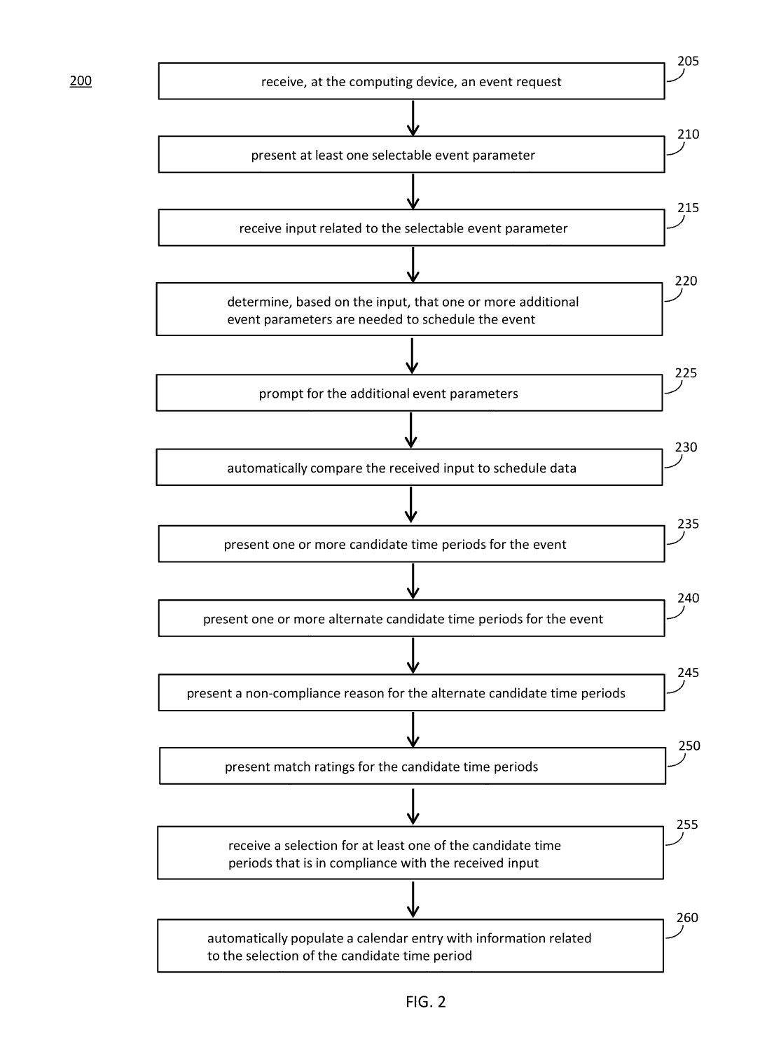

Referring to FIG. 2, a method 200 of scheduling an event at the computing device 100 is shown. It is important to note that the method 200 may include additional or even fewer steps or processes in comparison to what is illustrated in FIG. 2. Moreover, the method 200 is not necessarily limited to the chronological order that is shown in FIG. 2. In describing the method 200, reference may be made to FIGS. 1 and 3-5, although it is understood that the method 200 may be practiced with any other suitable systems, interfaces and components.

At step 205, an event request may be received at the computing device 100. In step 210, at least one event parameter may be presented, and input related to the event parameter may be received at step 215.

For example, a user may wish to schedule an event, such as a meeting that may involve multiple parties. As such, the user can select an event request by clicking on a “New Event” button on a calendar tool or by using some other suitable mechanism at the computing device 100. In another embodiment, the event request may further include one or more event parameters. For example, information received at the device 100 may indicate that a meeting needs to be scheduled and may also include other particulars about the meeting, such as the required participants.

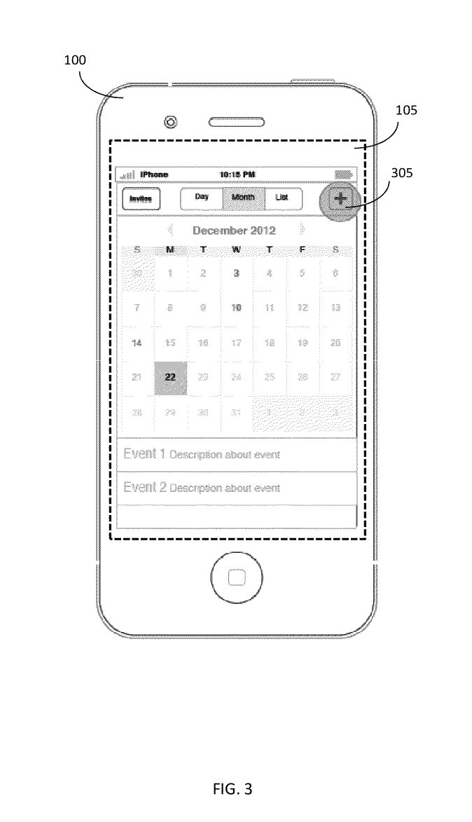

In one arrangement, an event request may be associated with an application 105 at the computing device 100, such as a calendar, which may be a stand-alone application 105 or may be included as part of another application 105, such as an email package. An example of a calendar application 105 is shown in FIG. 3. Receipt of the event request at the computing device 100 may be caused by the selection of a button, such as the “+” button 305, which may represent “New Meeting” or some other similar indication. In another example, appropriate navigation through a menu system of the calendar application 105 may cause the receipt of the event request. For instance, a user may first select “New” or similar from a top-level menu, and then select “Meeting” or similar from a list of choices presented in response. As described earlier, such interactions with the device 100 or the application 105 may occur in any suitable manner, including, but not limited to, the use of a mouse, keyboard, touch screen, camera, microphone, or any suitable component.

In another embodiment, an event request may be caused by an input that uses any suitable method of communication including visual, audio, written, or tactile. As an example, a text message received at the computing device 100 may include a phrase such as “new meeting” or “meeting request” or any phrase or shortcut that indicates that an event needs to be scheduled. As another example, an input message without such an explicit phrase may still include content that suggests that an event needs to be scheduled. For instance, it may be determined from the voice message “tomorrow, John, Bob, 3:00, main conference room, budget plans” that a meeting is to be scheduled. In these and other examples, the determination that an event needs to be scheduled may be performed through human or automatic monitoring of the input, an artificial intelligence tool, a voice recognition tool, a text parsing tool, or any appropriate method.

In one arrangement, an event request communicated through voice input may be received at the communication device 100 from one or more persons speaking into a microphone input which may or may not be part of the device 100. The voice input is not limited to this arrangement, however, and may include any suitable voice communication accessible to the device 100, including that from a phone, speaker phone, or network. For example, a remote user providing voice input may be in communication with the device 100 through a telephone network or any network that supports voice traffic. In another arrangement, the voice input may be a recorded voice message from one or more persons, or may be live or recorded artificial voice such as that resulting from a text-to-speech conversion tool or the like.

In another arrangement, an event request received through written input at the communication device 100 may be part or all of a text message, email, instant message, control message, data file, continuous text, or any suitable written communication. The written input may be real-time or may originate from saved data. In yet another arrangement, an event request may be received at the communication device 100 through tactile input. In addition to the previous example of touch screen interaction with the calendar application 105, tactile input may include the use of a touch screen or other component at the device 100 to compose a message that may be processed through previously described techniques, such as a text parsing tool.

Although these examples and embodiments serve to describe and illustrate an event request, they are not limiting, and any appropriate steps that indicate that an event needs to be scheduled may be an event request.

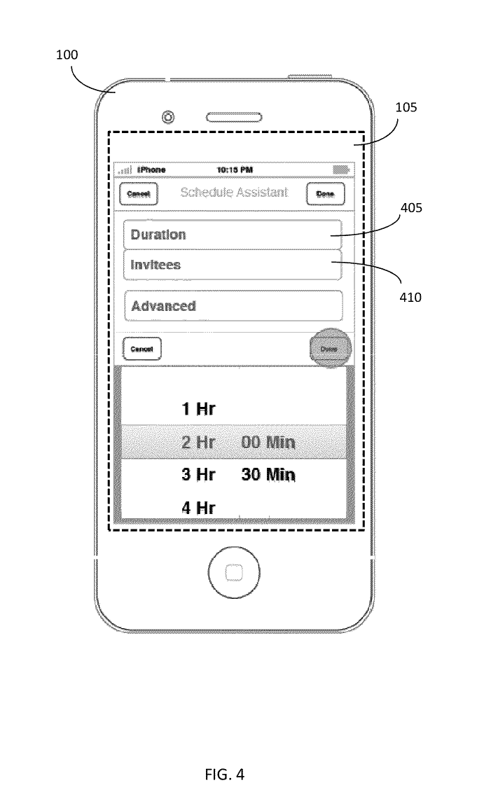

At least one event parameter that describes or conditions the event to be scheduled may be presented. The term “event parameter” is defined as one or more criteria that may affect the scheduling or particulars or an event. In one embodiment, the event parameter may be presented at the computing device 100 to prompt for input related to the parameter. For instance, in FIG. 4, the previously described example of the calendar application 105 is shown in a state in which two event parameters, the duration and the invitees, are presented in fields 405 and 410 for input from a user. Of course, other event parameters may be employed here.

In yet another embodiment, the event parameter may be presented at any suitable component(s) accessible to the computing device 100, in addition to or instead of being presented at the device 100. As an example, if a user communicates an event request to the device 100 from a remote terminal, the event parameter may be presented on a graphical display at the same remote terminal As another example, the event parameter may be presented in an email or text message, particularly if the event request was communicated to the device 100 in the same manner. For instance, a user may communicate a meeting request to the device 100 with an email, and may receive an email in response prompting the user to specify one or more parameters of the meeting.

It should be noted that a event parameter may be related to the event itself, to the computing device 100, to one or more users of the device 100, to one or more potential participants of the event, or to any other aspect of the event. In one example, the event parameter may be a last permissible time for the event. For instance, it may be necessary that a company meeting take place at some point during the current week, in which case “Friday at 5:00 P.M.” may be the last permissible time. In another example, the event parameter may be a duration of time for the event, which may be given in any appropriate time unit, such as hours, fractions of hours, minutes, days or the like. In another example, the event parameter may be a list of the required (or desired) participants for the event. The list may be part of a contact list, such as a company address book or a personal contact list of the user of the device 100, but should not be so limited and the list of participants may originate from any appropriate source. It should be noted that a participant may refer not only to a person, but may also refer to a device, application, or any other component. For instance, in the scheduling of a company meeting, an overhead projector or a software package required for the meeting may be considered a participant, particularly if only one or few such items are available in the company.

In yet another example, the event parameter can be a time preference parameter or a time restriction parameter. In one arrangement, a time preference parameter may cause a certain time period, such as “afternoons only,” to be considered as part of the process of determining candidate time periods for the event, which will be described later. In another arrangement, a time restriction parameter may exclude certain time periods from consideration as candidate time periods for the event. For instance, an employee of a company may want to schedule a meeting such that non-business hours of the company are excluded from consideration for the meeting time. Although this non-exhaustive list of examples illustrates possible event parameters, a event parameter is not so limited, and any appropriate parameter that describes or conditions the event may be an event parameter.

As mentioned earlier, presentation of the event parameter may be performed in response to the receipt of the event request, as in the example of the calendar application 105 shown in FIG. 4, but should not be limited to that arrangement. In another arrangement, one or more event parameters can be presented by default before an event request actually occurs. For instance, the default screen may present not only the button 305 to cause an event request (the “+” button for “New meeting”), but may also present event parameters such as duration and invitees, in the fields 405 and 410 in the same screen. Selecting the button 305 or filling in any of the fields 405 or 410 may serve as an event request.

Input related to an event parameter may be received at the communication device 100 or some other suitable component through any of the methods of interaction or communication previously described regarding the receipt of an event request. Referring to the example of the calendar application 105 shown in FIG. 4, the user may provide input related to the duration of the desired meeting in the field 405 through touch interaction that may include scrolling through a drop-down list of possible durations. In another arrangement, a user may send an email or a text message that includes an event parameter such as a required list of participants. In yet another arrangement, input related to a event parameter may be stored in the memory 140 of the computing device 100, and may be retrieved in response to an event request. For instance, a user may store previous meeting preferences such as time restrictions, which may potentially apply to any meeting that this user needs to schedule. It should be noted that input related to multiple event parameters may be received concurrently, for example if several fields like 405 and 410 are filled out before submission with a keystroke such as “Enter.” Reception of the input should not be so limited, however, as complete or partial inputs may be received in a single step or multiple steps.

Inputs that are related to event parameters are not necessarily limited to parameters that are predefined selections from a menu on the communication device 100 or through some other interface that is used to present such selections. For example, referring to FIG. 4, the predefined blocks of time shown there, such as “1 Hr,” “2 Hr 00 Min,” and “3 Hr 30 Min,” may be replaced by a slot that can accept time periods entered by the user of the communication device 100. Similarly, the “Invitees” interface does not necessarily have to be linked to a predefined contact list, as the user may simply enter suitable contact information that can be used to identify a participant.

As previously described, in some embodiments, the original event request may already include input related to one or more of the event parameters needed to schedule the event. This input may be used in the scheduling process, or may be combined with other input and used in the scheduling process. As an example, a user may send a text message that requests a meeting and includes only the required participants for the meeting. Future input related to the desired meeting time may be combined with the already received list of required participants to schedule the event.

At step 220, it may be determined that one or more additional event parameters are needed to schedule the event, and prompting for the additional event parameters may be performed at step 225. Input related to the additional event parameters may be received, and may be combined with other input, such as event parameter input already received.

It may be necessary that at least a certain group of required event parameters be specified, through user input or any method, before the event can be scheduled. For example, scheduling of a company meeting may require that at least the last permissible time, duration, and required participants be specified. The required event parameters should not be so limited, however, as the group may include fewer, additional, or different parameters than those in the example. In addition, even for the same user, company, device or the like, different events may be characterized by different required event parameters. The required parameters for an event may be determined by any appropriate entity, such as the user of the computing device 100 or an IT administrator, or may be determined by or included on an application 105 such as the calendar application previously described.

The event parameters already specified, through user input or any other method, may be compared to the group of required event parameters to determine which event parameters, if any, have not been specified. As an example, if a user performs an event request with the text message “meeting, before Friday 5:00, one hour,” the event parameters of last permissible time and duration may be identified. A comparison with the group of last permissible time, duration, and required participants may determine that the required participants are still needed in order to schedule the meeting. In another example, an invalidly specified parameter may also be considered as unspecified. For instance, continuing the previous example, the text message “meeting, before Friday 5:00, one hour, with John” specifies that John is a participant. However, if an associated contact list does not include anybody named John, the submitted list of participants may be invalid, and therefore may be considered as not unspecified.

In response to the determination of which event parameters are still needed, input related to the missing parameters may be requested using any of the techniques and components previously described regarding the presentation of an event parameter. Furthermore, additional input related to the missing or other event parameters may be received using any of the previous techniques. The additional input may be combined with previous input related to event parameters, or a portion or all of the additional input may replace the previous input for use in the scheduling process described below.

In step 230, the event parameter input may be automatically compared to schedule data. One or more candidate time periods for the event may be presented in step 235, and one or more alternate candidate time periods may be presented in step 240. In step 245, a non-compliance reason for the alternate candidate time periods may be presented. Match ratings for any of the time periods may be presented in step 250.

The schedule data used in the comparison may include a schedule of at least one of the potential participants, a schedule of operational hours of an organization, information from a social networking tool, or any other relevant information that may affect the determination of appropriate time periods for the event. As an example, the schedule data may include open time periods for each potential participant. For instance, time periods in a user's calendar that have no entries or are noted in the calendar as open, not busy, available, tentative or similar may be considered open. As another example, information from a social networking tool, such as a planned vacation of a potential participant, may be included in the schedule data. Schedule data may also include a granularity of time periods for which the comparison is performed, and any granularity may be used. For instance, a granularity of 15 minutes may cause the candidate time periods to begin on a certain hour, or at 15, 30, or 45 minutes past the hour, while a granularity of 30 minutes may cause the periods to begin on the hour or 30 minutes past the hour.

Schedule data may also include one or more events external to the organization, such as a natural disaster, emergency, or holiday. For instance, during a local emergency, persons in a certain geographic area may be ordered to stay inside and to not travel. This restriction may be included as part of the schedule data in the determination of an appropriate time for a meeting or other event, particularly if one of the potential participants or the proposed meeting site is located within that area.

The automatic comparison of the input with the schedule data may be performed in any suitable manner to determine time periods for the event. The comparison may be performed at the communication device 100 or at any other suitable location, such as a remote server or an external device. In one embodiment, any time period that complies with the input and the schedule data may be determined to be a candidate time period. As an example, if a meeting must take place in the current week for one hour and must include John, Bob, and Frank according to the specified event parameters, any time period of one hour during the current week in which John, Bob, and Frank are all available (or not busy or similar) may be considered a candidate time period. In another embodiment, multiple candidate time periods that comply with the input and schedule data may overlap. For example, the one hour duration in the previous example may occur between 3:00 and 4:00 in one candidate time period, and between 3:30 and 4:30 of the same day in another candidate time period.

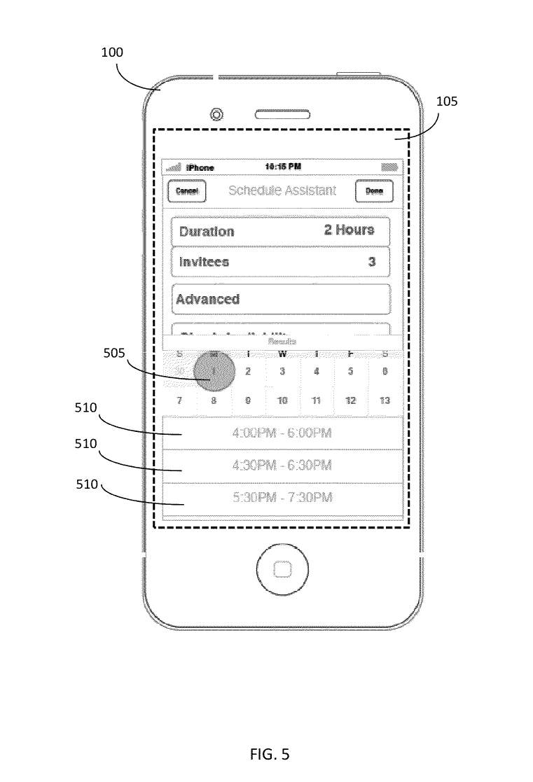

The candidate time periods may be presented at the computing device 100 or at any suitable location as described earlier. The example in FIG. 5 shows the calendar application 105 at the computing device 100 presenting date 505 and times 510 of candidate time periods. Note that, in this particular example, selection of the date 505 may cause the candidate times 510 occurring on the date 505 to be displayed. In one embodiment, days in the calendar application 105 that contain a candidate time period may be distinguishable from days that do not contain a candidate time, such as through highlighting, bold face, italic font, or any other suitable differentiator. The presentation of candidate time periods should not be limited to this arrangement, however, and any suitable method may be used. In another example, a simple listing of all the times without categorization by date may be used.

In another embodiment, a time period that is in partial compliance with the input or the schedule data may be determined to be an alternate candidate time period by the automatic comparison of the input with the schedule data. In addition, the reason(s) for the alternate candidate time period not being in full compliance with the input or schedule data may be determined and presented as non-compliance reasons. In one arrangement, alternate candidate time periods may be determined only when no candidate time periods exist, but in another arrangement, they may be determined even when one or more candidate time periods exists.

Several examples of alternate candidate time periods will be given below, in conjunction with an example meeting that requires 12 participants for 30 minutes on or before Tuesday. In one example, an alternate period may be a 30 minute block of time on Tuesday in which 11 of the 12 required participants are available, but one required participant, Bob, is unavailable. Bob's unavailability may be a non-compliance reason. As another example, a 30 minute time period on Wednesday in which all 12 participants are available may also be an alternate candidate time period. But the fact that the time period occurs after the specified deadline of Tuesday is a non-compliance reason. As yet another example, a 30 minute time period on Thursday in which only 10 of the 12 potential participants are available may be an alternate candidate time period. In this example, non-compliance reasons are related to the two event parameters (last permissible time and required participants) that are non-compliant.

Although not shown in the example of FIG. 5, alternate candidate time periods may also be presented in any suitable manner as previously described. In one embodiment, alternate candidate time periods may be presented even when candidate time periods exist. For instance, alternate periods may be differentiated from the candidate periods through color, italic font, or any suitable technique. In another embodiment, the alternate periods may be presented only when no candidate time periods exist. In addition, the non-compliance reasons may be presented along with the alternate candidate time periods.

To characterize a level of compliance (or non-compliance or partial compliance) of the candidate and alternate candidate time periods, match ratings may be generated. For instance, if a meeting requires 12 participants, an alternate candidate time period in which 11 of the 12 participants are available may be considered more desirable than an alternate candidate time period in which only two of the participants are available, and match ratings may characterize these two alternate candidate time periods accordingly. The match ratings for the candidate or alternate candidate time periods may be presented at the computing device 100 or at any suitable location as described earlier. The presentation of the match ratings may facilitate a user, component, or device in selecting a time period for the event. As an example, the user may prefer candidate time periods that occur before lunch, and such time periods may be displayed at the top of the list according to some match ratings. As another example, if no candidate time periods are available, the user may wish to see the alternate candidate time periods that are “close” in some sense, which may be characterized by match ratings and displayed accordingly.

The match rating for a time period may be given as a percentage on a scale of zero to 100 percent, the number or fraction of specified event parameters satisfied by the time period, a categorization such as “good match” or “bad match,” or any other appropriate measure that characterizes how well, or how poorly, the time period matches against the specified event parameters. In one arrangement, the alternate candidate time periods may be rated according to preferences (from user input or any source) associated with any of the event parameters. For instance, a user may consider satisfying the last permissible time for the event as the most important event parameter, and may be less concerned about accommodating all the potential participants.

A technique for generating match ratings may assign weights to the event parameters and may measure the amount of disagreement for the event parameters not satisfied by the alternate candidate time period. In one example, if the last permissible time, duration, and required participants for the event are specified, the formula may give equal weights to the three parameters. In another example, the parameters may be weighted differently to account for one of the parameters being considered more important than another. In another example, the amount of disagreement for the last permissible time may be the number of days after the specified time that the alternate candidate time period occurs. In yet another example, the amount of disagreement for the required participants may be the number, or percentage, of required participants that are unavailable during the alternate candidate time period. Thus, the amount of disagreement may be based on some value that reflects the dissonance between an alternate time period parameter and a requested parameter.

In one arrangement, the candidate time periods may be assigned a value of 100 percent, good match or the like, as all event parameters are satisfied for the candidate time periods. In another arrangement, the candidate time periods may be rated according to any suitable criteria. As an example, chronological ratings may be used, in which the earliest candidate time period is rated the highest and the latest time period is rated the lowest. In another arrangement, the candidate time periods may be rated according to a preference, such as user input to an application 105. In one example, higher match ratings may be assigned to time periods occurring in the afternoon. In another example, lower match ratings may be assigned to time periods that overlap a lunch period. Although these arrangements and examples serve to illustrate possible match ratings for the candidate and alternate candidate time periods, they are not meant to be limiting, and any suitable method, formulas, measurements or the like may be used to generate the match ratings.

In step 255, a selection may be received for at least one of the candidate time periods that is in compliance with the received input. In addition, a selection for at least one of the alternate candidate time periods may also be received. In both cases, the selection may be received at the computing device 100 in any suitable manner as previously described. For instance, a user may select a time period for the event through touch or a mouse-click in response to presentation of the candidate or alternate candidate time periods on a graphical display included in the device 100.

In step 260, a calendar entry may be automatically populated with information related to the selection of the candidate or alternate candidate time period. For example, the calendars of some or all the scheduled participants of the event may be automatically populated to account for the now-scheduled event. In addition, this or other information, such as the fact that the event is to be scheduled during the selected time period, may be presented at the communication device 100 or may be communicated to a user, component, or other device. For instance, the organizer of the event may be prompted to perform an action such as accepting the time period or refining the search.

While various embodiments have been described above, it should be understood that they have been presented by way of example only, and not limitation. It will be understood by those skilled in the relevant art(s) that various changes in form and details may be made therein without departing from the spirit and scope of the subject matter as defined in the appended claims. Accordingly, the breadth and scope of the present subject matter should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

What is claimed is:

1. A method of scheduling an event at a computing device, comprising:
receiving, at the computing device, an event request;
in response to the receipt of the event request, presenting at least one event parameter;
receiving input related to the at least one event parameter;
automatically comparing the received input to schedule data; and
based on the comparison of the received input to the schedule data, presenting one or more candidate time periods for the event that are in compliance with the received input.

2. The method according to claim 1, wherein the event parameter is a last permissible time for the event, a duration of time for the event, a list of potential participants to be invited to the event, a time preference parameter, or a time restriction parameter.

3. The method according to claim 2, wherein the list of potential participants is from a contact list.

4. The method according to claim 1, wherein the candidate time periods for the event are in full compliance with the received input.

5. The method according to claim 4, further comprising presenting one or more alternate candidate time periods that are in partial compliance with the received input.

6. The method according to claim 5, further comprising presenting a non-compliance reason for the alternate candidate time periods.

7. The method according to claim 1, further comprising:
receiving a selection for at least one of the candidate time periods that is in compliance with the received input; and
automatically populating a calendar entry with information related to the selection of the candidate time period.

8. The method according to claim 1, further comprising presenting match ratings for the candidate time periods, wherein the match ratings are based on the compliance of the candidate time periods with the received input.

9. The method according to claim 2, wherein the schedule data comprises a schedule of at least one of the potential participants, a schedule of operational hours of an organization, or information from a social networking tool.

10. The method according to claim 2, wherein the schedule data further comprises an event external to an organization.

11. A method of scheduling an event at a computing device, comprising:
receiving, at the computing device, an event request that includes input related to at least one event parameter comprising a last permissible time for the event, a duration of time for the event, or a list of potential participants to be invited to the event;
automatically comparing the input with schedule data to generate one or more candidate time periods for the event in accordance with the input; and
presenting the candidate time periods for the event.

12. The method according to claim 11, further comprising presenting at least one event parameter from a set of event parameters to enable the receipt of the input related to the event parameter.

13. The method according to claim 11, further comprising:
determining, based on the input, that one or more additional event parameters are needed to schedule the event; and
prompting for the additional event parameters.

14. The method according to claim 11, wherein the generated candidate time periods are in full compliance with the received input and the method further comprises presenting one or more alternate candidate time periods that are non-compliant with at least a portion of the received input.

15. The method according to claim 11, wherein presenting the candidate time periods for the event comprises presenting the candidate time periods in a calendar format such that days that are part of a calendar and that contain a candidate time period are distinguishable from days that are part of the calendar that do not contain candidate time periods.

16. The method according to claim 11, wherein the schedule data comprises a schedule of at least one of the potential participants, a schedule of operational hours of an organization, or information from a social networking tool.

17. The method according to claim 11, wherein the input further comprises a time preference parameter, and the method further comprises:
comparing the one or more candidate time periods with the time preference parameter to produce a set of match ratings; and
presenting the set of match ratings.

18. A computing device, comprising:
an interface that is configured to receive input from a user and to present information to the user; and
a processing unit that is communicatively coupled to the interface;
wherein the interface is further configured to:
receive an event request;
in response to the receipt of the event request, present at least one event parameter from a set of event parameters comprising a last permissible time for the event, a duration of time for the event, or a list of potential participants to be invited to the event;
receive input related to the at least one event parameter and communicate the input to the processing unit;
based on an automatic comparison of the received input to a set of schedule data, present one or more candidate time periods for the event;
wherein the processing unit is configured to perform the automatic comparison and to generate the candidate time periods.

19. The computing device according to claim 18, wherein the interface is a touch display.

20. The computing device according to claim 18, wherein the set of event parameters further comprises a time preference parameter or a time restriction parameter.
